(19) United States
(12) Patent Application Publication
(10) Pub. No.: US 2020/0057468 A1
(43) Pub. Date: Feb. 20, 2020

(54) MID-FRAME MEMBERS

(71) Applicant: Hewlett-Packard Development Company, L.P., Spring, TX (US)

(72) Inventors: Chi-Chun Chiang, Taipei City (TW); Cheng-Han Tsai, Taipei City (TW); Chia-Ming Tsai, Taipei City (TW); Hung-Yen Chi, Taipei City (TW)

(73) Assignee: Hewlett-Packard Development Company, L.P., Spring, TX (US)

(21) Appl. No.: 16/605,044

(22) PCT Filed: Apr. 24, 2017
(86) PCT No.: PCT/US2017/029127

§ 371 Date: Oct. 14, 2019

(51) Int. Cl. G06F 1/16; B21D 22/02; B21D 28/26

(52) U.S. Cl. CPC G06F 1/1613; B21D 28/26; B21D 22/02

(57) ABSTRACT

Aspects relating to a mid-frame member (100) and methods of forming the mid-frame member (100) are described. In an example, the mid-frame member (100) includes a first planar component (102) having a plurality of first trapezoid-shaped grooves (106) and formed of a first metal. The mid-frame member (100) also includes a second planar component (104) having a plurality of second trapezoid-shaped grooves (108) and formed of a second metal. A crest between adjacent second trapezoid-shaped grooves (108) cooperates with a first trapezoid-shaped groove to form dovetail joints between the first planar component (102) and the second planar component (104).

### BACKGROUND

Mid-frames are supporting structures formed as part of a body of a device, such as laptops, tablet computers, and hand-held devices. For the reason that the devices in recent times are portable, the mid-frames are made to be strong yet light-weight at the same time, and are therefore, usually made of aluminum. Given intricate shapes in which mid-frames are made, CNC (Computer Numerical Control) machines are usually employed for the entire manufacturing process of making mid-frames.

### BRIEF DESCRIPTION OF FIGURES

The detailed description is provided with reference to the accompanying figures. It should be noted that the description and the figures are merely examples and are not meant to represent the subject matter itself.

FIG. 1 illustrates a schematic of a mid-frame member, according to an example.

FIG. 2 illustrates a schematic of a device employing the mid-frame member, according to an example.

FIG. 3A illustrates a top-view of the mid-frame member in a non-assembled state, according to an example.

FIG. 3B illustrates the top-view of the mid-frame member in an assembled state, according to an example.

FIG. 4 illustrates a method for forming the mid-frame member, according to an example.

### DETAILED DESCRIPTION

Manufacturing of mid-frames usually involves use of CNC (Computer Numerical Control) machines, owing to the intricate shapes that the mid-frames might take. However, such a manner of manufacturing mid-frames by CNC may not be cost-effective since the time taken for machining may be high and the output obtained may be commensurately low. Few designs, instead, use magnesium mid-frames which are manufactured by die-casting. However, magnesium mid-frames that are manufactured by die-casting may not be sufficiently strong and may not pass free-drop test criteria. Some recent designs have, therefore, used a combination of aluminum and magnesium for manufacturing mid-frames. In such designs, outer material of the mid-frame is aluminum which provides stiffness and strength, whereas inner material is magnesium which enhances the strength but does not add to the weight. In such designs, however, the aluminum and magnesium may not be bonded properly, which may lead to structural defects in the body of the device. In addition, the manufacturing of the aluminum portion of the mid-frame is still achieved by CNC, which may drive up the cost of the mid-frames given the inherent cost intensiveness of such a manufacturing process.

The present subject matter relates to aspects of manufacturing a mid-frame member for a device using two metals, such as aluminum and magnesium, in a manner that the two metals are firmly coupled to each other. Accordingly, the mid-frame member is formed of two components—a first planar component formed of a first metal and a second planar component formed of a second metal. Given the planar shape of the mid-frame member, the first planar component and the second planar component are also planar structures. The two planar components are provided with complimentary grooves which fit into each other and cooperate to firmly couple the two planar components together.

In the present subject matter, in case where the first planar component is perimetrically outside the second planar component, the first planar component has a plurality of first trapezoid-shaped grooves formed along its inner perimeter or the inner peripheral edge. Similarly, the second planar component has a plurality of second trapezoid-shaped grooves formed along its outer peripheral edge or along the outer perimeter. The two sets of trapezoid-shaped grooves on the respective metal component are complimentary to each other such that each crest between adjacent grooves on the second planar component fits into a groove on the first planar component. Accordingly, a plurality of dovetail joints is formed between the first planar component and the second planar component, to effectively couple the two planar components together. In addition, a coupling element, such as a threaded screw, can be used to strengthen the joint between the two metal components.

Such a construction of the mid-frame member allows combination of the features of two different materials, such as strength durability, and light-weight, into the mid-frame member. For example, when one of the planar members is formed of aluminum and the other is formed of magnesium, the overall weight of the mid-frame member is substantially low whereas the strength is high. For instance, such a mid-frame member can be durable enough to pass the free-drop test criteria. At the same time, the manufacturing of the mid-frame member is simple and involves low cost in terms of time and equipment, and still the mid-frame member so formed has high quality. For instance, in the above example where the first planar member is perimetrically outside the second planar member, and the two are formed of substantially elastic materials, such as metals, the grooves in the first planar member can be formed by stamping and the grooves in the second planar member can be formed by die-cutting. In either case, the tolerances of the fit between the two planar members can be within sufficient limits, such that the members may not have to be additionally machined or processed for assembling. In other words, when the mid-frame is formed in accordance with the present subject matter, high accuracy for the purposes of assembling the components to form the mid-frame component can be achieved, whereas the cost of manufacturing is substantially low.

The above aspects are further described in the figures and in associated description below. It should be noted that the description and figures merely illustrate principles of the examples discussed herein. Therefore, various arrangements that encompass the principles of the examples discussed herein, although not explicitly described or shown herein, can be devised from the description and are included within its scope. Additionally, the word “coupled” is used throughout for clarity of the description and can include either a direct connection or an indirect connection.

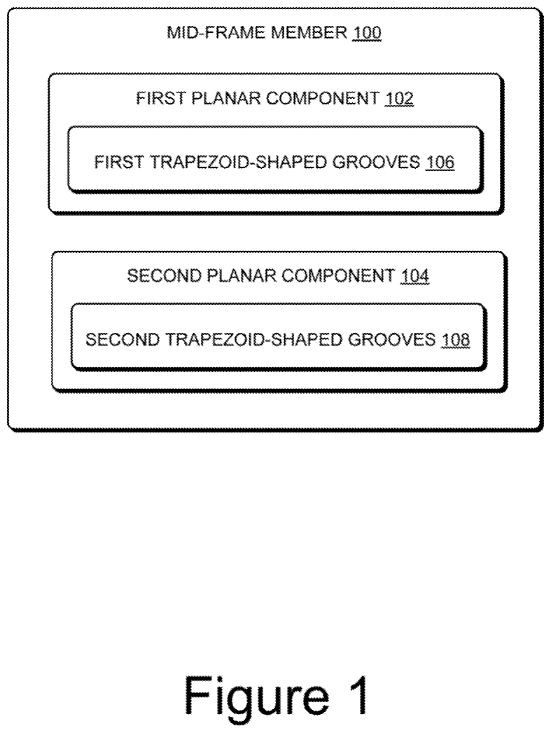

FIG. 1 illustrates a schematic of a mid-frame member 100, according to an example. The mid-frame member 100 can be employed in any electrical, electronic, or similar device, for instance, for structural strength of a chassis or body of the device. The mid-frame member 100 may be formed of two metals conjoined together, instead of being mixed as an alloy. Such a construction can substantially simplify the manufacturing and allow the manufacturer to select the proportion of the two metals to be used for making the mid-frame member 100.

In the example illustrated in FIG. 1, the mid-frame member 100 includes a first planar component 102 and a second planar component 104. The planar components 102, 104 can be formed from sheet metal and, therefore, can be in the form of profiled metallic sheets. As part of manufacturing the mid-frame member 100 with high strength and low weight, the two planar components 102 and 104 can be made of different metals. Accordingly, the first planar component 102 can be formed of a first metal and the second planar component 104 can be made of a second metal.

Further, to couple the two planar components 102 and 104 together in an effective manner, the two planar components 102 and 104 have corresponding joining structures formed thereon. For instance, where the first planar component 102 forms the perimetrically outer portion of the mid-frame member 100, the first planar component 102 can have a plurality of first trapezoid-shaped grooves 106 formed on an inner perimeter thereof. In other words, along the inner peripheral edge, the first planar component 102 can have a set of first trapezoid-shaped grooves 106, referred to as a first trapezoid-shaped groove 106 when being referred to individually.

To match the first trapezoid-shaped grooves 106 on the first planar component 102, the second planar component 104 can have a plurality of second trapezoid-shaped grooves 108 formed on an outer perimeter thereof, and referred to as a second trapezoid-shaped groove 108 when being referred to individually. Given the shape of the second trapezoid-shaped grooves 108, the crests between adjacent second trapezoid-shaped grooves 108 are of the shape to conform to the shape of the first trapezoid-shaped grooves 106. To form the mid-frame member 100, each crest between adjacent second trapezoid-shaped grooves 108 is fitted into a first trapezoid-shaped groove 1068, thereby forming a plurality of dovetail joints between the first planar component 102 and the second planar component 104. When the dovetail joints are formed, all the crests on the second planar component 104, formed by the second trapezoid-shaped grooves 108, fit into respective first trapezoid-shaped grooves 106 on the first planar component 102. In the jointed state, the first planar component 102 and the second planar component 104 are co-planar, i.e., they share a common plane.

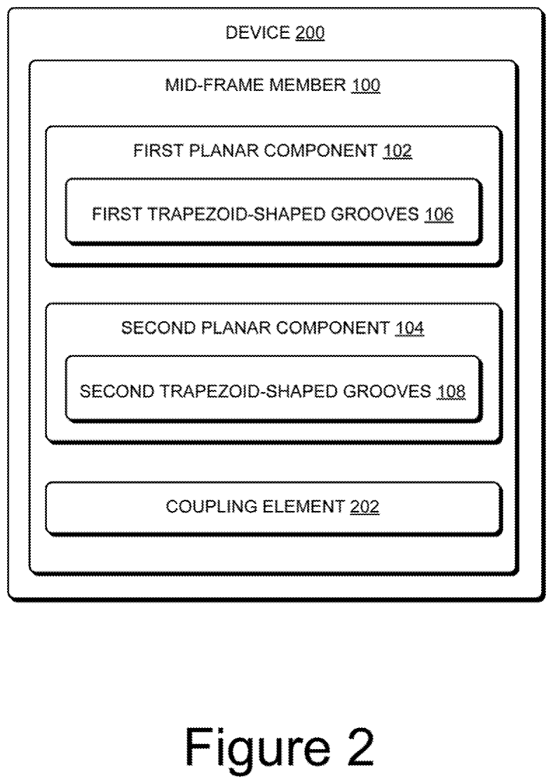

FIG. 2 illustrates a schematic of a device 200 employing the mid-frame member 100, according to another example. In one example, the device 200 can be an electronic device, such as a laptop computer, a desktop computer, or a handheld device, for instance, a tablet computer, a personal digital assistant, or a mobile phone. In another example, the device 200 can be an electrical or mechanical device, or any other device employing the mid-frame member 200 for supporting a body or chassis of the device 200. In the above-mentioned examples, the mid-frame member 100 can be a supporting structure of the device 200, for instance, as part of the frame or body of the device 200.

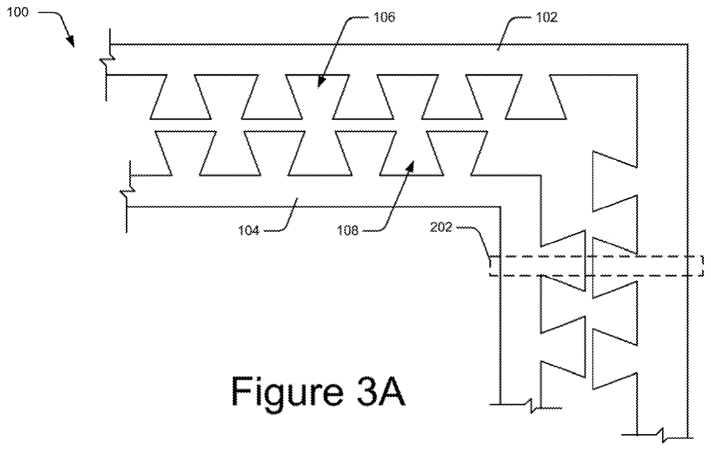

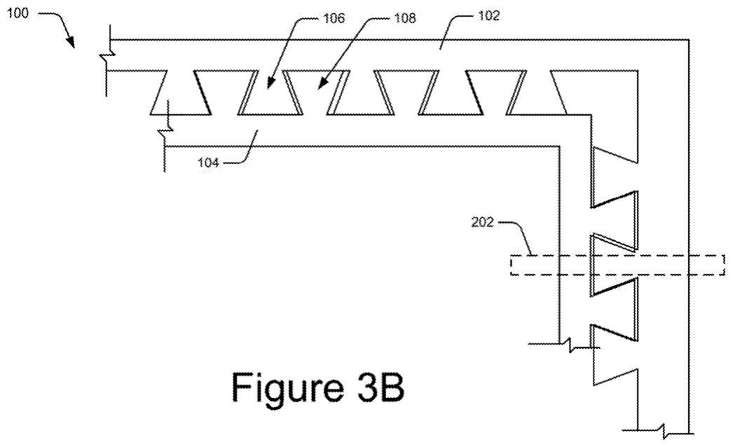

While the mid-frame member 100 shown in FIG. 2 is structurally the same as that shown in FIG. 1, the mid-frame member 100 of the example shown in FIG. 2 includes a coupling element 202. The coupling element 202 extends longitudinally through the first planar component 102 and the second planar component 104, along the planes of the planar components 102 and 104. The coupling element 202, therefore, holds the first planar component 102 to the second planar component 104, in addition to the dovetail joints. The mid-frame member 100 and the various components thereof are explained in detail with reference to FIG. 3.

FIGS. 3A and 3B illustrate a top view of the mid-frame member 100, according to an example. FIG. 3A illustrates the mid-frame member 100 in a non-assembled state and FIG. 3B illustrates the mid-frame member 100 in an assembled state. While the assembled state shown in FIG. 3B illustrates the edges of the first planar component 102 and those of the second planar component 104 overlapping or distant from each other, in actual assembled state, the edges of the planar components 102, 104 are flush with each other, for example, for effective joint strength. For the sake of brevity and ease of understanding, FIGS. 3A and 3B are described in conjunction.

As mentioned previously, the mid-frame member 100 includes the first planar component 102 having the first trapezoid-shaped grooves 106 and the second planar component 104 having the second trapezoid-shaped grooves 108. In the assembled state, shown in FIG. 3B, the crests between one set of grooves 106, 108 on one of the planar component 102, 104 fit into the grooves 108, 106 of the other planar component 104, 102 to form a plurality of dovetail joints. The mid-frame member 100 is, therefore, able to combine the characteristics of the materials of the first planar component 102 and the second planar component 104. For example, the first planar component 102 can be formed of a first metal, such as aluminum or an alloy thereof. In said example, the second planar component 104 can be formed of a second metal, such as magnesium or an alloy thereof. In such a case, the mid-frame member 100 can have the combined attributes of both aluminum and magnesium, and is constructionally simple.

In other examples, that in some implementations, the first planar component 102 and the second planar component 104 may have different numbers of trapezoid-shaped grooves 106, 108 from each other. In such a case, in the assembled state, few trapezoid-shaped grooves 106, 108 may receive the crests formed between the other set of trapezoid-shaped grooves 108, 108. Conversely, few of the crests formed between the trapezoid-shaped grooves 106, 108 may be accommodated in the other set of trapezoid shaped grooves 108, 106.

In another example, in addition to the dovetail joints, the first planar component 102 and the second planar component 104 can be joined by additional structure(s) to strengthen the coupling between the two. Such an additional connection can make the coupling in the mid-frame member 100 durable. The coupling element 202 can be used to tie the first planar component 102 and the second planar component 104 together. Though FIG. 3A illustrates the mid-frame member 100 in a non-assembled state, the coupling element 202 is shown to be assembled in that figure for illustration purposes.

For instance, the first planar component 102 and the second planar component 104 can each have a cavity formed therein, the cavities extending longitudinally along the respective planes of the planar components 102, 104. In addition, when the planar components 102, 104 are assembled, the respective cavities can align with each other and the planar components 102, 104 can be co-planar. Accordingly, the coupling element 202 can be inserted into the cavity to longitudinally extend along the plane of the first planar component 102 and the plane of the second planar component 104, now being common, and join the two planar components 102, 104 together.

In one example, the coupling element 202 can be formed as a separate part made of a third metal, different from the first metal and the second metal of the first planar component 102 and of the second planar component 104, respectively. For instance, the coupling element 202 can be made of steel or iron or any other metal or an alloy of such metals, and can be formed as a rivet or a screw, or another type of mechanical fastener. The selection of the third metal for the coupling element 202 as separate from the first and second metal can allow for a substantial cost reduction of the mid-frame member 100.

In another example, the coupling element 202 can be formed integrally with either the first planar component 102 or the second planar component 104. In said example, again, the coupling element 202 can be integrally formed with one planar component 102, 104 and the other planar component 104, 102 can have the cavity to receive the coupling element 202. To assemble the first planar component 102 and the second planar component 104, the coupling element 202 on one can be inserted and fitted into the cavity of the other. For example, in case the coupling element 202 is formed integrally with the first planar component 102, which is perimetrically outside the second planar component 104 when assembled, the coupling element 202 can extend from the inner perimeter or the inner peripheral edge of the first planar component 102 along the plane of the first planar component 102. A corresponding cavity formed in the second planar component 104, aligned along the plane of the second planar component 104, receives the coupling element 202 of the first planar component 102 to tie the two together. Similarly, the coupling element 202 can be formed integrally with the second planar component 104 and the cavity can be formed in the first planar component 102.

According to aspects discussed above, a thickness of the first planar component 102, for instance, made of aluminum, can be selected to be substantially low. For example, the thickness of the first planar component 102 can be 0.5 millimeter, whereas the thickness of the second planar component 104, for instance, made of magnesium, can be high in comparison to that of the first planar component 102. Accordingly, an appropriate combination of strength, weight, and costs can be achieved while manufacturing the mid-frame member 100.

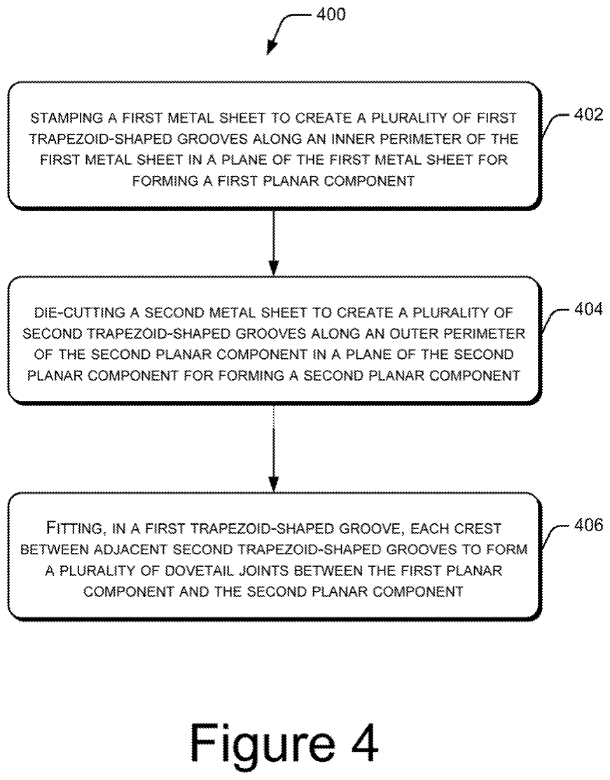

FIG. 4 illustrates a method for forming the mid-frame member 100 described above, in accordance with an example. The order in which the method 400 is described is not intended to be construed as a limitation, and any number of the described method blocks can be combined in any appropriate order to carry out the method 400 or an alternative method. Additionally, individual blocks may be deleted from the method 400 without departing from the spirit and scope of the subject matter described herein.

Referring to FIG. 4, at block 402, a first metal sheet is stamped to create the plurality of first trapezoid-shaped grooves 106 along an inner perimeter of the first metal sheet, thereby, forming the first planar component 102. The first trapezoid-shaped grooves 106 are formed to lie in a plane of the first metal sheet. In other words, the first metal sheet is stamped to form an indented cavity in the body of the first metal sheet, a rim of the cavity formed as having the first trapezoid-shaped grooves 106. In said example, the first planar component 102 forms the perimetrically outer portion of the mid-frame member 100. The first metal sheet is made of a first metal, such as aluminum or an alloy thereof.

At block 404, a second metal sheet is die-cut to create the plurality of second trapezoid-shaped grooves 108 along an outer perimeter of the second metal sheet for forming the second planar component 104. In the same manner as that for the first metal sheet, the second trapezoid-shaped grooves 108 are also formed in a plane of the second metal sheet, and conform to the plurality of first trapezoid-shaped grooves 106. In other words, the crests of one set of trapezoid-shaped grooves 106, 108 conform to the grooves in the other set 108, 106. The second metal sheet is formed of a second metal, such as magnesium or an alloy thereof.

At block 406, a crest, a first crest, or each crest between adjacent second trapezoid-shaped grooves 108 in the second planar component 104 is fitted to cooperate with a first trapezoid-shaped groove 106 in the first planar component 102. Such a cooperation of the two sets of the trapezoid-shaped grooves 106, 108 forms a plurality of dovetail joints between the first planar component 102 and the second planar component 104.

When the dovetail joints are formed, all the crests on the second planar component 104, formed by the second trapezoid-shaped grooves 108, fit into respective first trapezoid-shaped grooves 106 on the first planar component 102. In the jointed state, the first planar component 102 and the second planar component 104 are co-planar, i.e., they share a common plane.

Further, in another example, a coupling element 202 can be inserted longitudinally along the common plane and through the first planar component 102 and the second planar component 104, to reinforce the joint between the two components 102, 104. The coupling element 202 can be formed of a third metal which is different from the first metal and the second metal of the respective planar components 102, 104. In said example, as part of steps at blocks 402 and 404, respectively, the first planar component 102 and the second planar component 104 can each have a cavity formed therein. The cavities can extend longitudinally along the respective planes of the planar components 102, 104. When the planar components 102, 104 are assembled, the respective cavities can align with each other such that the coupling element 202 can be inserted into the cavity to join the two planar components 102, 104.

In another example, the coupling element 202 can be integrally part of one of the planar components 102, 104, in which case the planar component 102, 104 is manufactured with the coupling element 202 as a part thereof. For example, in case the coupling element 202 is part of the first planar component 102, as part of the step at block 402, a guide pin can be formed in the first planar component 102 to extend longitudinally from the inner perimeter of the first metal sheet along the plane of first metal sheet. The guide pin functions as the coupling element 202. A corresponding cavity is formed in the second metal sheet, as part of the step at block 404, to accommodate the guide pin to tie the first planar component 102 and the second planar component 104 together.

In another case, where the coupling element 202 is a part of the second planar component 104, as part of the step at block 404, the guide pin can be formed to extend longitudinally from the outer perimeter of the second metal sheet along the plane of second metal sheet. Further, in a manner similar to that explained above, at block 402, a corresponding cavity can be formed in the first metal sheet to receive the guide pin in the second planar component 104 to tie the two planar components 102, 104 together.

Although aspects of the mid-frame member 100 and the manufacturing thereof have been described in language specific to structural features and/or methods, it is to be understood that the appended claims are not limited to the specific features or methods described. Rather, the specific features and methods are disclosed as examples of the mid-frame member 100 and the manufacturing thereof.

I/We claim:

1. A mid-frame member comprising:
a first planar component comprising a plurality of first trapezoid-shaped grooves formed along an inner perimeter of the first planar component in a plane of the first planar component, the first planar component being formed of a first metal; and
a second planar component comprising a plurality of second trapezoid-shaped grooves formed along an outer perimeter of the second planar component in a plane of the second planar component, the second planar component being formed of a second metal, wherein a crest between adjacent second trapezoid-shaped grooves in the second planar component cooperates with a first trapezoid-shaped groove in the first planar component to form a plurality of dovetail joints between the first planar component and the second planar component.

2. The mid-frame member as claimed in claim 1, wherein the first metal is one of aluminum and an alloy thereof, and wherein the second metal is one of magnesium and an alloy thereof.

3. The mid-frame member as claimed in claim 1 further comprising a coupling element longitudinally extending along the plane of one of the first planar component and of the second planar component to join the first planar component and the second planar component.

4. The mid-frame member as claimed in claim 3, wherein the coupling element is formed integrally with one of the first planar component and the second planar component.

5. The mid-frame member as claimed in claim 3, wherein the coupling element is formed of a third metal different from the first metal and the second metal.

6. A device comprising:
a mid-frame member comprising,
a first planar component comprising a plurality of first trapezoid-shaped grooves formed along an inner perimeter of the first planar component in a plane of the first planar component, the first planar component being formed of a first metal;
a second planar component comprising a plurality of second trapezoid-shaped grooves formed along an outer perimeter of the second planar component in a plane of the second planar component, the second planar component being formed of a second metal, wherein each crest between adjacent second trapezoid-shaped grooves in the second planar component cooperates with a first trapezoid-shaped groove in the first planar component to form a plurality of dovetail joints between the first planar component and the second planar component; and
a coupling element longitudinally extending along the plane of the first planar component and the plane of the second planar component to join the first planar component and the second planar component.

7. The device as claimed in claim 6, wherein the first metal is aluminum and the second metal is magnesium.

8. The device as claimed in claim 6, wherein the coupling element is formed integrally with one of the first planar component and the second planar component.

9. The device as claimed in claim 6, wherein the coupling element is separate from the first planar component and the second planar component, the coupling element being formed of a third metal different from the first metal and the second metal.

10. A method for forming a mid-frame member, the method comprising:
stamping a first metal sheet to create a plurality of first trapezoid-shaped grooves along an inner perimeter of the first metal sheet in a plane of the first metal sheet for forming a first planar component; and
die-cutting a second metal sheet to create a plurality of second trapezoid-shaped grooves along an outer perimeter of the second metal sheet in a plane of the second metal sheet for forming a second planar component, wherein the plurality of second trapezoid-shaped grooves conform to the plurality of first trapezoid-shaped grooves; and
fitting a crest between adjacent second trapezoid-shaped grooves in the second planar component to cooperate with a first trapezoid-shaped groove in the first planar component to form a plurality of dovetail joints between the first planar component and the second planar component.

11. The method as claimed in claim 10, further comprising inserting longitudinally a coupling element along the plane of the first planar component and the second planar component through the first planar component and the second planar component to join the first planar component and the second planar component.

12. The method as claimed in claim 10, wherein the stamping comprises forming a guide pin to extend longitudinally from the inner perimeter of the first metal sheet along the plane of first metal sheet to fit into a corresponding cavity in the second metal sheet.

13. The method as claimed in claim 10, wherein the die-cutting comprises forming a guide pin to extend longitudinally from the outer perimeter of the second metal sheet along the plane of second metal sheet to fit into a corresponding cavity in the first metal sheet.

14. The method as claimed in claim 10, wherein the first metal sheet is formed of one of aluminum and an alloy thereof, and wherein the second metal sheet is formed of one of magnesium and an alloy thereof.

15. The method as claimed in claim 14, wherein a thickness of the first metal sheet is about 0.5 millimeter.
